(19) United States
(12) Patent Application Publication
(10) Pub. No.: US 2025/0276591 A1
(43) Pub. Date: Sep. 4, 2025

(54) EV Charger Socket Locking Design

(71) Applicant: Computime Limited, Hong Kong (HK)

(72) Inventors: Wai Yin Shum, Hong Kong (HK); Chi Shing Ho, Hong Kong (HK)

(21) Appl. No.: 18/978,027

(22) Filed: Dec. 12, 2024

Related U.S. Application Data
(60) Provisional application No. 63/559,340, filed on Feb. 29, 2024.

(51) Int. Cl. B60L 53/16; H01R 13/629; H01R 13/635; H01R 13/642; H01R 43/26

(52) U.S. Cl. CPC B60L 53/16; H01R 13/62977; H01R 13/635; H01R 13/642; H01R 43/26; H01R 2201/26

(57) ABSTRACT

An EV charger locking system includes a plunger, one or more springs, and an electrically controlled actuator. The plunger contacts a lockable portion of an EV charger inserted into a channel of an EV charging socket. When uncompressed, the one or more springs position a tip of the plunger in a return position in or above a hole of the channel. When compressed, the one or more springs apply a force in a second direction to return the tip to the return position. When activated, the actuator applies a mechanical force to the plunger in a first direction to move the tip through the hole and to position the tip in a locking position in the channel to contact the lockable portion. When deactivated, the actuator removes the mechanical force from the plunger, allowing the plunger to be returned to the return position by the one or more springs.

### RELATED APPLICATIONS

This application claims the benefit of U.S. Provisional Patent Application Ser. No. 63/559,340, filed on Feb. 29, 2024, the content of which is incorporated by reference herein in its entirety.

### FIELD OF THE INVENTION

The teachings herein relate to a locking mechanism in an electric vehicle (EV) charging socket. More particularly the teachings herein relate to apparatus and methods for automatically locking an EV charger in an EV charging socket.

### BACKGROUND

There are numerous reports of EV chargers falling out of charging sockets or becoming disengaged from charging sockets while charging. There are also reports of EV chargers becoming stuck in or jamming charging sockets after charging is completed.

EV charger disengagement is a significant problem due to the long charging times required for EVs and the fact that, due to the long charging times, EV chargers are often left unattended. As a result, any disengagement of an EV charger from a charging socket can result in a significant delay in charging an EV.

EV charger jamming is also a significant problem because it reduces the availability of an already limited amount of EV chargers available. A jammed EV charger connection not only inconveniences the current person charging their EV, it also prevents others from using that EV charger.

EV charger disengagement or jamming can occur for many different reasons. For example, due to normal wear and tear, an EV charger may become loose in a socket. Consequently, the charger or its locking mechanism may no longer fit snugly and connect properly with a socket. Alternatively, the loose fit may allow the charger to be misaligned causing it to jam or get stuck in the socket.

User error may also contribute to EV charger disengagement or jamming in a socket. A user may not properly insert and align an EV charger in a socket. As a result, the EV charger may disengage from the socket or even fall out during charging. Alternatively, a user may apply too much pressure to a misaligned engagement causing the EV charger to jam.

The environment of the charger may also contribute to EV charger disengagement or jamming. In certain climates, the charger may be exposed to excessive humidity, dust, or corrosive materials. This may cause the charger or its components to change shape leading to connection problems with a socket or leading to the charger becoming stuck in a socket.

Finally, EV chargers come in all shapes and sizes. Some have long cables and some have short cables. Some have thick cables, while others have thin cables. These varied characteristics can contribute to EV charger disengagement or jamming. For example, a connector with a long thick cable is likely to place more force on a connection between the EV charger and socket and result in the EV charger disengaging or jamming.

Consequently, there is an unmet need for systems and methods that can prevent EV chargers from disengaging from sockets during charging and prevent them from jamming or getting stuck in sockets after charging.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is an exemplary three-dimensional diagram showing how an electrically controlled locking mechanism housing is connected to an EV charging socket, in accordance with various embodiments.

FIG. 3 is an exemplary cross-sectional diagram showing how an electrically controlled locking mechanism is connected internally to an EV charging socket, in accordance with various embodiments.

FIG. 4 is an exemplary cross-sectional diagram showing how an electrically controlled locking mechanism connected to an EV charging socket locks an EV charger during charging, in accordance with various embodiments.

FIG. 5 is an exemplary cross-sectional diagram showing how an electrically controlled locking mechanism connected to an EV charging socket unlocks an EV charger after charging, in accordance with various embodiments.

FIG. 6 is a series of exemplary cross-sectional diagrams showing how an electrically controlled locking mechanism connected to an EV charging socket prevents an EV charger from becoming jammed in the EV charging socket when removal of the EV charger is attempted before the electrically controlled locking mechanism is completely disengaged after charging, in accordance with various embodiments.

FIG. 7 is an exemplary cross-sectional diagram showing how an electrically controlled locking mechanism that includes a rotary motor driven actuator is connected internally to an EV charging socket, in accordance with various embodiments.

FIG. 8 is an exemplary cross-sectional diagram showing how an electrically controlled locking mechanism that includes a rotary motor driven actuator and is connected to an EV charging socket locks an EV charger during charging, in accordance with various embodiments.

FIG. 9 is an exemplary cross-sectional diagram showing how an electrically controlled locking mechanism that includes a rotary motor driven actuator and is connected to an EV charging socket unlocks an EV charger after charging, in accordance with various embodiments.

FIG. 10 is series of exemplary cross-sectional diagrams showing how an electrically controlled locking mechanism that includes a rotary motor driven actuator and is connected to an EV charging socket prevents an EV charger from becoming jammed in the EV charging socket when removal of the EV charger is attempted before the electrically controlled locking mechanism is completely disengaged, in accordance with various embodiments.

FIG. 11 is an exemplary flowchart showing a method for locking an EV charger in an EV charging socket, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

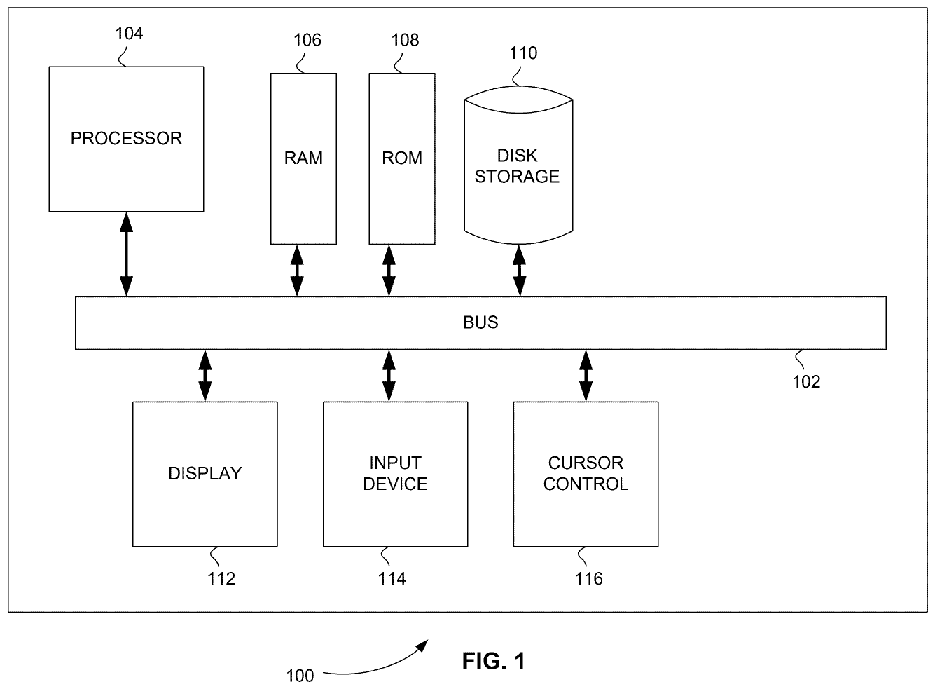

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random-access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein.

Alternatively, hard-wired circuitry may be used in place of or in combination with software instructions to implement the present teachings. For example, the present teachings may also be implemented with programmable artificial intelligence (AI) chips with only the encoder neural network programmed—to allow for performance and decreased cost. Thus, implementations of the present teachings are not limited to any specific combination of hardware circuitry and software.

The term “computer-readable medium” or “computer program product” as used herein refers to any media that participates in providing instructions to processor 104 for execution. The terms “computer-readable medium” and “computer program product” are used interchangeably throughout this written description. Such a medium may take many forms, including but not limited to, non-volatile media and volatile media. Non-volatile media includes, for example, optical or magnetic disks, such as storage device 110. Volatile media includes dynamic memory, such as memory 106.

Common forms of computer-readable media include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium.

The computer-readable medium can be a device that stores digital information. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Electrically Controlled EV Charger Lock

As described above, there are numerous reports of EV chargers falling out of charging sockets or becoming disengaged from charging sockets while charging. There are also reports of EV chargers becoming stuck in or jamming charging sockets after charging is completed.

EV charger disengagement is a significant problem due to the long charging times required for EVs and the fact that, due to the long charging times, EV chargers are often left unattended. As a result, any disengagement of an EV charger from a charging socket can result in a significant delay in charging an EV.

EV charger jamming is also a significant problem because it reduces the availability of an already limited amount of EV chargers available. A jammed EV charger connection not only inconveniences the current person charging their EV, it also prevents others from using that EV charger.

EV charger disengagement or jamming can occur for many different reasons, including, but not limited to, normal wear and tear, user error, environmental factors, and the varied characteristics of EV chargers.

In various embodiments, EV charger disengagement or jamming is prevented by modifying an EV charging socket to include an automatic locking mechanism for locking an inserted EV charger to the EV charging socket. The locking mechanism is made to be automatic by placing it under electrical control. An automatic or electrically controlled locking mechanism is less susceptible to EV charger disengagement or jamming. This is because an automatic or electrically controlled locking mechanism is less susceptible to, for example, normal wear and tear, user error, environmental factors, and the varied characteristics of EV chargers.

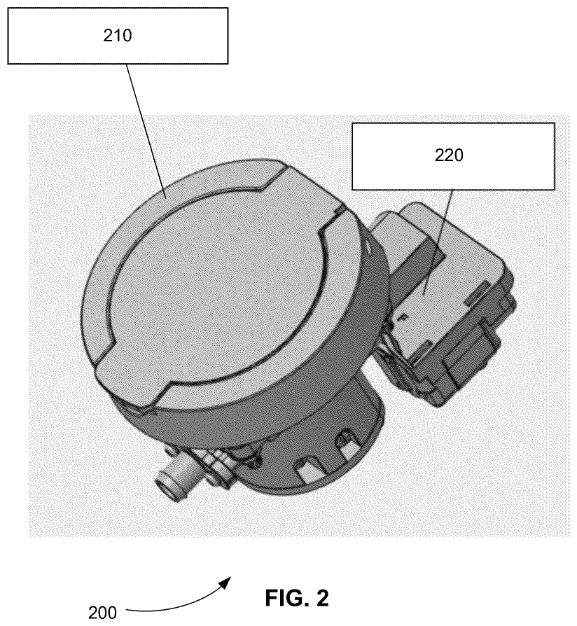

FIG. 2 is an exemplary three-dimensional diagram 200 showing how an electrically controlled locking mechanism housing is connected to an EV charging socket, in accordance with various embodiments. In FIG. 2, electrically controlled locking mechanism housing 220 is shown connected to EV charging socket 210 beyond the opening of EV charging socket 210 in order to be able to engage the lockable portion of an inserted EV charger (not shown).

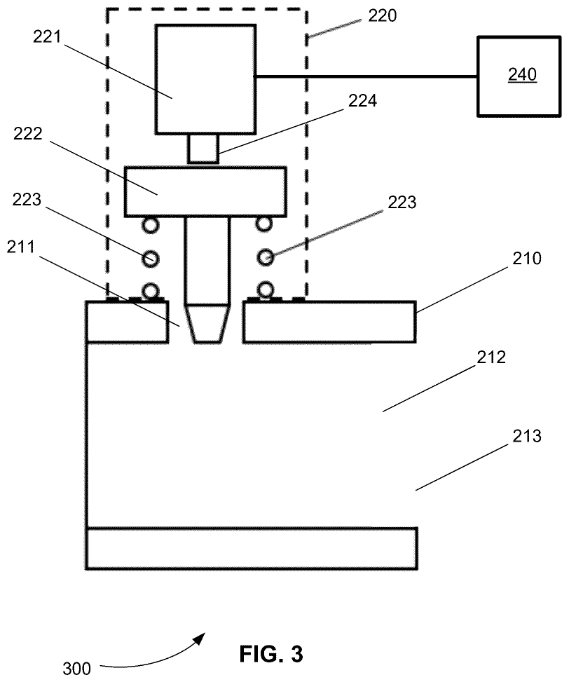

FIG. 3 is an exemplary cross-sectional diagram 300 showing how an electrically controlled locking mechanism is connected internally to an EV charging socket, in accordance with various embodiments. In FIG. 3, electrically controlled locking mechanism housing 220 is connected to the outside of EV charging socket 210. Electrically controlled locking mechanism housing 220 includes the electrically controlled locking mechanism.

The electrically controlled locking mechanism includes electrically controlled actuator 221, plunger or lock pin 222, and one or more springs 223. Electrically controlled actuator 221 is, for example, an electromagnetic actuator or solenoid. EV charging socket 210 includes a hole 211 into channel 212. Hole 211 is located in a wall of channel 212 beyond opening 213 into which an EV charger can be inserted. The electrically controlled locking mechanism is positioned above hole 211 so that plunger 222 can be extended through hole 211 and into channel 212 of EV charging socket 210.

In various embodiments, plunger 222 is not always connected to shaft 224 of actuator 221. For example, shaft 224 may only be physically connected to plunger 222 when actuator 221 is activated. As shown in FIG. 3, actuator 221 is not activated. Consequently, plunger 222 is not in contact with shaft 224, and one or more springs 223 cause plunger 222 to be pushed upward through hole 211 so that plunger 222 does not affect the insertion or removal of an EV charger into or out of channel 212.

In various embodiments, electrically controlled actuator 221 is activated or deactivated using electrical circuitry 240. Electrical circuitry 240 detects when the EV charger is charging or not charging. For example, electrical circuitry 240 can be electrically connected to the terminals of EV charging socket 210 and, therefore, can determine whether or not electric current is being supplied to the terminals of EV charging socket 210.

In various embodiments, electrical circuitry 240 can include one or more processors. The one or more processors can be, but are not limited to, controllers, computers, microprocessors, computer systems such as the computer system of FIG. 1, or any devices capable of sending and receiving control signals or data and analyzing data. In other words, electrically controlled actuator 221 can be activated or deactivated by receiving controlled signals from one or more processors.

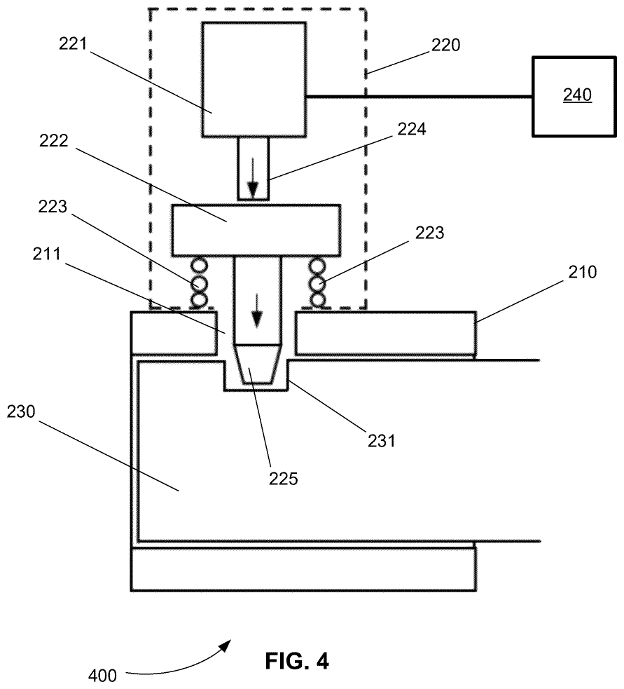

FIG. 4 is an exemplary cross-sectional diagram 400 showing how an electrically controlled locking mechanism connected to an EV charging socket locks an EV charger during charging, in accordance with various embodiments. In FIG. 4, EV charger 230 has been inserted into the channel of EV charging socket 210. EV charger 230 includes lockable portion or notch 231.

To lock EV charger 230 to or in EV charging socket 210, electrically controlled actuator 221 of the electrically controlled locking mechanism is activated. This causes electrically controlled actuator 221 to extend shaft 224 downward making contact with and pushing plunger 222 downward also. This downward movement of plunger 222 causes one or more springs 223 to be compressed. It also causes plunger 222 to move down through hole 211 of EV charging socket 210, to engage notch 231 of EV charger 230, and to lock EV charger 230 to EV charging socket 210. Note that actuator 221 remains activated throughout charging in order to keep EV charger 230 locked to EV charging socket 210.

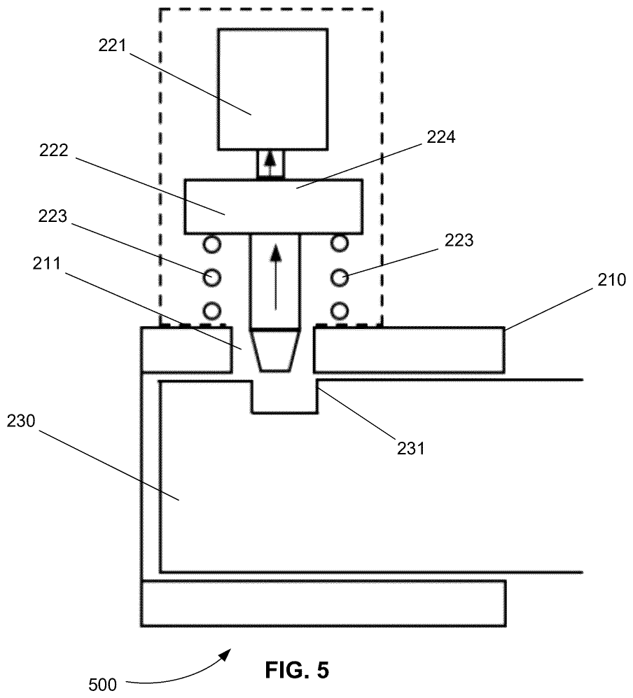

FIG. 5 is an exemplary cross-sectional diagram 500 showing how an electrically controlled locking mechanism connected to an EV charging socket unlocks an EV charger after charging, in accordance with various embodiments. In FIG. 5, electrically controlled actuator 221 has been deactivated in order to unlock EV charger 230.

The deactivation of actuator 221 causes shaft 224 to move upward and remove the pressure on plunger 222. In turn, one or more springs 223 cause plunger 222 to also move upward and out of notch 231 of EV charger 230. The movement of plunger 222 upward through hole 211 and out of the channel of EV charging socket 210 unlocks EV charger 230 from EV charging socket 210 and allows EV charger 230 to be removed from socket 210.

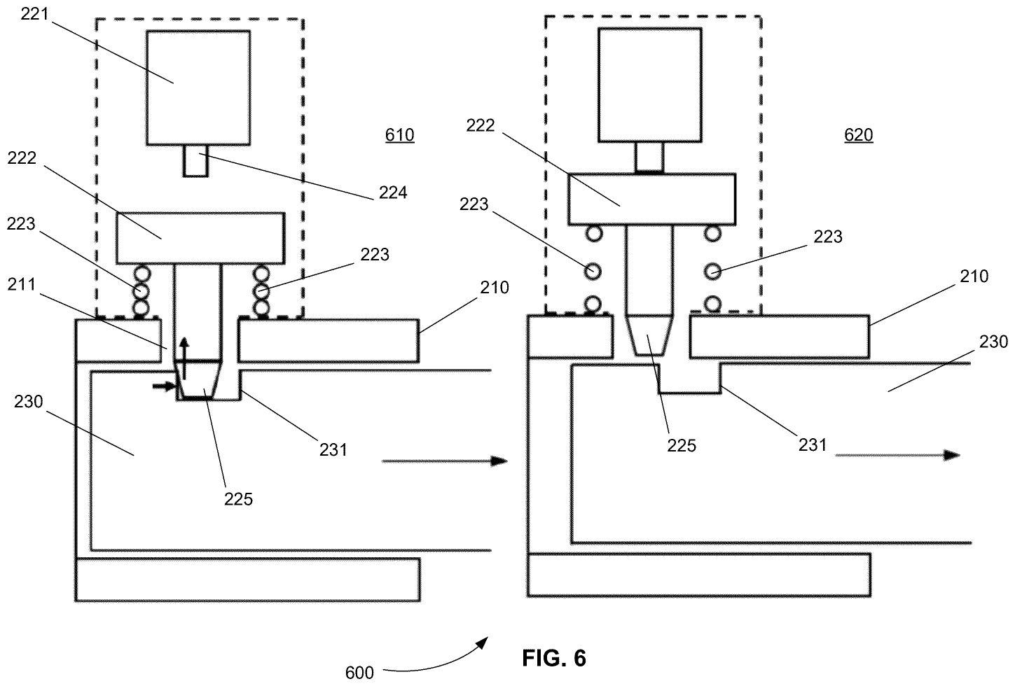

FIG. 6 is series 600 of exemplary cross-sectional diagrams showing how an electrically controlled locking mechanism connected to an EV charging socket prevents an EV charger from becoming jammed in the EV charging socket when removal of the EV charger is attempted before the electrically controlled locking mechanism is completely disengaged after charging, in accordance with various embodiments. In diagram 610, charging has ended and electrically controlled actuator 221 has been deactivated, causing shaft 224 to move upward and away from plunger 222. However, a user has attempted to remove EV charger 230 from EV charging socket 210 before plunger 222 has fully disengaged from notch 231. Conventionally, such an attempt can cause a jam.

In various embodiments, however, tip or pin portion 225 of plunger 222 that comes in contact with notch 231 is chamfered or angled to prevent a jam. A jam is prevented because, when EV charger 230 is pulled from EV charging socket 210, an edge of notch 231 contacts angled tip 225 causing plunger 222 to move upward. In other words, if the edge of notch 231 and the tip of plunger 222 are parallel flat surfaces, a jam could be created when the parallel surfaces come together when the removal of EV charger 230 is attempted. The force applied by the removal of EV charger 230 against the parallel surfaces may produce enough perpendicular frictional force between the parallel surfaces to counteract the upward force produced on plunger 222 by one or more springs 223.

However, because plunger 222 includes angled tip 225, when the flat edge of notch 231 contacts angled tip 225, less perpendicular frictional force is produced. Thus, the upward force produced on plunger 222 by one or more springs 223 can overcome the frictional force, causing angled tip 225 to be moved upward.

In diagram 620, the upward force produced on plunger 222 by one or more springs 223 has completely overcome the frictional force produced between the flat edge of notch 231 and angled tip 225. As a result, plunger 222 has been completely removed from the channel of EV charging socket 210. EV charger 230 is, therefore, able to be freely moved out of EV charging socket 210. Thus, the combination of one or more springs 223 and angled tip 225 provides an auto return function for plunger 222 and prevents a possible jam.

### Rotary Motor Driven Actuator

In various embodiments, actuator 221 of FIG. 6 is a rotary motor driven actuator.

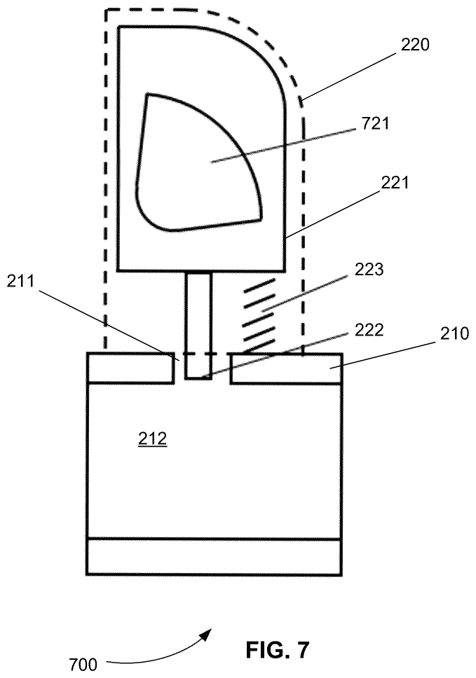

FIG. 7 is an exemplary cross-sectional diagram 700 showing how an electrically controlled locking mechanism that includes a rotary motor driven actuator is connected internally to an EV charging socket, in accordance with various embodiments. In FIG. 7, electrically controlled locking mechanism housing 220 is connected to the outside of EV charging socket 210. Electrically controlled locking mechanism housing 220 includes the electrically controlled locking mechanism.

The electrically controlled locking mechanism includes electrically controlled actuator 221, plunger or lock pin 222, and one or more springs 223. Electrically controlled actuator 221 includes rotary motor 721.

EV charging socket 210 includes a hole 211 into channel 212. Hole 211 is located in a wall of channel 212. The electrically controlled locking mechanism is positioned above hole 211 so that plunger 222 can be extended through hole 211 and into channel 212 of EV charging socket 210.

In various embodiments, plunger 222 is connected to actuator 221. As shown in FIG. 7, actuator 221 is not activated. When actuator 221 is activated, rotary motor 721 turns moving actuator 221 down and, in turn, moving plunger 222 down through hole 211 and into channel 212. When actuator 221 is not activated, one or more springs 223 keep actuator 221 in a position above EV charging socket 210 and, in turn, keep plunger 222 above channel 212.

In various embodiments, electrically controlled actuator 221 is activated or deactivated using electrical circuitry (not shown). The electrical circuitry detects when the EV charger is charging or not charging. For example, the electrical circuitry can be electrically connected to the terminals of EV charging socket 210 and, therefore, can determine whether or not electric current is being supplied to the terminals of EV charging socket 210.

In various embodiments, electrical circuitry 240 can include one or more processors. The one or more processors can be, but are not limited to, controllers, computers, microprocessors, computer systems such as the computer system of FIG. 1, or any devices capable of sending and receiving control signals or data and analyzing data. In other words, electrically controlled actuator 221 can be activated or deactivated by receiving controlled signals from one or more processors.

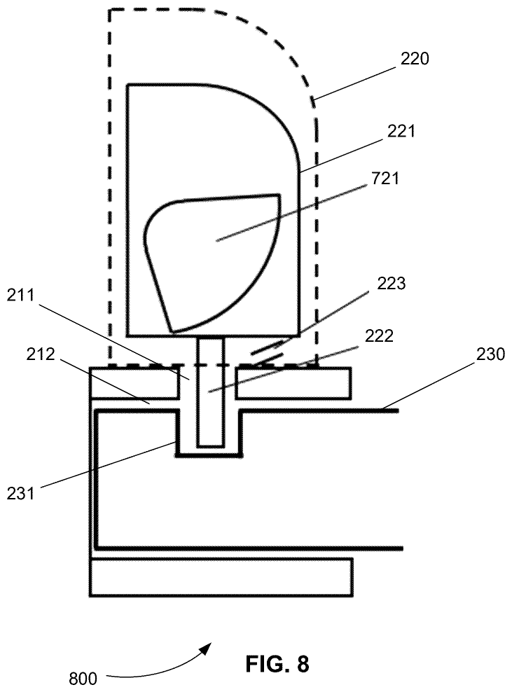

FIG. 8 is an exemplary cross-sectional diagram 800 showing how an electrically controlled locking mechanism that includes a rotary motor driven actuator and is connected to an EV charging socket locks an EV charger during charging, in accordance with various embodiments. In FIG. 8, EV charger or charging gun 230 has been inserted into channel 212 of EV charging socket 210. EV charger 230 includes lockable portion or notch 231.

To lock EV charger 230 to or in EV charging socket 210, electrically controlled actuator 221 of the electrically controlled locking mechanism is activated. This causes rotary motor 721 to turn moving actuator 221 downward and, in turn, plunger 222 downward also. Rotary motor 721, for example, moves clockwise to move actuator 221 downward. This downward movement of plunger 222 causes one or more springs 223 to be compressed. It also causes plunger 222 to move down through hole 211 of EV charging socket 210, to engage notch 231 of EV charger 230, and to lock EV charger 230 to EV charging socket 210. Note that actuator 221 remains activated throughout charging in order to keep EV charger 230 locked to EV charging socket 210.

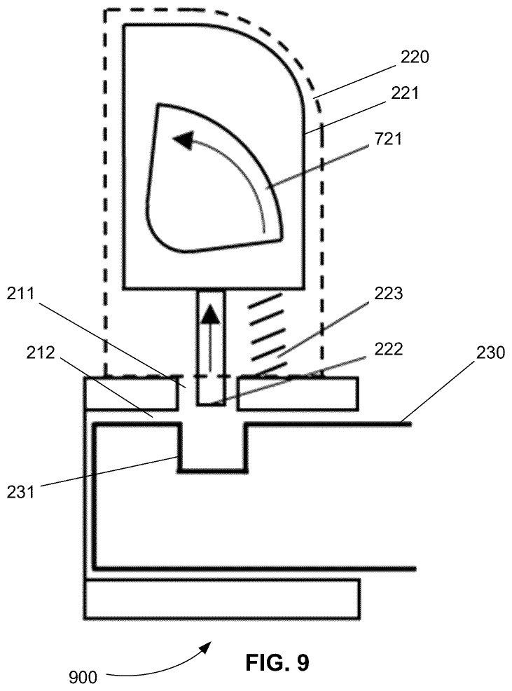

FIG. 9 is an exemplary cross-sectional diagram 900 showing how an electrically controlled locking mechanism that includes a rotary motor driven actuator and is connected to an EV charging socket unlocks an EV charger after charging, in accordance with various embodiments. In FIG. 9, electrically controlled actuator 221 has been deactivated in order to unlock EV charger 230. The deactivation causes rotary motor 721 to move counterclockwise.

The deactivation of actuator 221 allows one or more springs 223 to move actuator 221 and, in turn, plunger 222 to move upward and out of notch 231 of EV charger 230. The movement of plunger 222 upward through hole 211 and out of the channel of EV charging socket 210 unlocks EV charger 230 from EV charging socket 210 and allows EV charger 230 to be removed from socket 210.

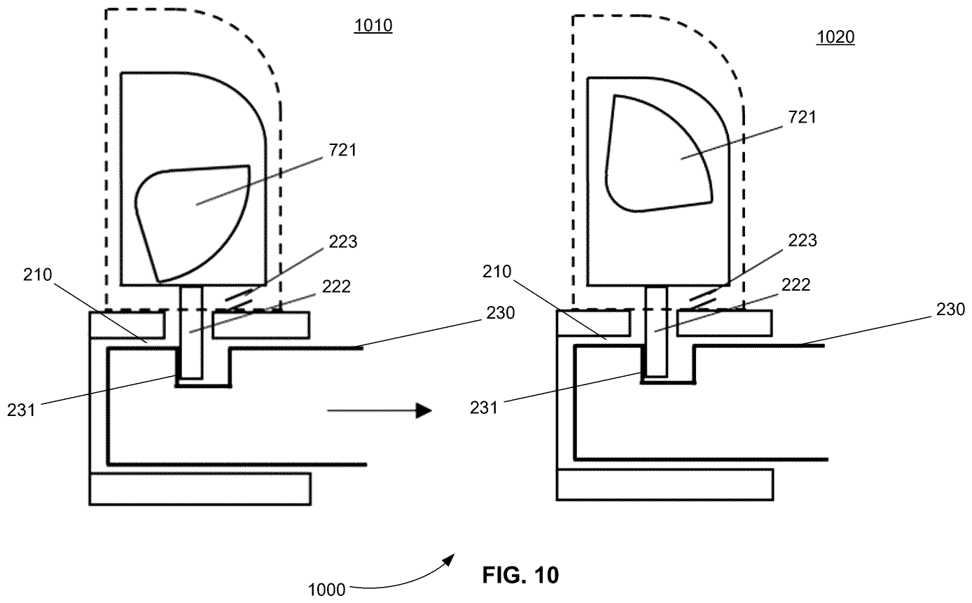

FIG. 10 is series 1000 of exemplary cross-sectional diagrams showing how an electrically controlled locking mechanism that includes a rotary motor driven actuator and is connected to an EV charging socket prevents an EV charger from becoming jammed in the EV charging socket when removal of the EV charger is attempted before the electrically controlled locking mechanism is completely disengaged, in accordance with various embodiments. In diagram 1010, charging has not ended. However, a user has attempted to remove EV charger 230 from EV charging socket 210 before plunger 222 is disengaged from notch 231. This causes plunger 222 and notch 231 to be in contact. After charging has ended, this contact can result in a jam due to the contact between plunger 222 and notch 231.

Diagram 1020 shows that after charging contact between plunger 222 and notch 231 can result in a jam. The contact between plunger 222 and notch 231 produces enough frictional force to counteract the pressure produced by one or more springs 223. In other words, one or more springs 223 cannot move plunger 222 upward.

Also, if rotary motor 721 is left in the activated position, it also produces additional pressure preventing the jam from being cleared. In various embodiments, however, to allow a user to clear the jam, rotary motor 721 moves counterclockwise, as shown in diagram 1020, back to the deactivated position. This relieves the additional pressure of rotary motor 721. Now the user can clear the jam by simply moving EV charger 230 forward. This releases the pressure and one or more springs 223 are able to move plunger 222 upward and out of EV charging socket 210, as shown in FIG. 9.

### Locking System

Returning to FIG. 4, the electrically controlled EV charger locking system includes plunger 222, one or more springs 223, and electrically controlled actuator 221. Plunger 222 physically contacts lockable portion 231 of EV charger 230 inserted into a channel of EV charging socket 210. When uncompressed, one or more springs 223 position tip 225 of plunger 222 in a return position or location in or above hole 211 of the channel of socket 210. When compressed, one or more springs 223 apply a force in a second direction to return tip 225 to the return position.

When activated, electrically controlled actuator 221 applies a mechanical force to plunger 222 in a first direction, which is opposite the second direction, to move tip 225 through hole 211 and to position tip 225 in a locking position in the channel to contact lockable portion 231 of charger 230. When deactivated, electrically controlled actuator 221 removes the mechanical force from plunger 222, allowing plunger 222 to be returned to the return position by one or more springs 223.

In various embodiments, tip 225 is angled to prevent parallel surface contact between tip 225 and lockable portion 231 of charger 230.

In various embodiments, lockable portion 231 includes a notch or slit.

In various embodiments, plunger 222, one or more springs 223, and electrically controlled actuator 221 are enclosed in housing 220 connected to socket 210.

In various embodiments, electrically controlled actuator 221 includes a solenoid or rotary motor.

In various embodiments, electrically controlled actuator 221 receives an electrical signal to activate and an electrical signal to deactivate from electrical circuitry 240.

In various embodiments, electrical circuitry 240 includes one or more processors.

In various embodiments, the electrical signal to activate is received when electrical circuitry 240 detects that charger 230 is charging socket 210.

In various embodiments, the electrical signal to deactivate is received when electrical circuitry 240 detects that charger 230 is not charging socket 210.

### Locking Method

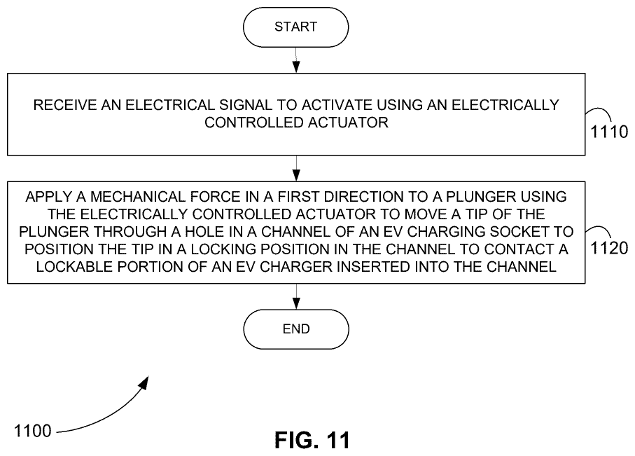

FIG. 11 is an exemplary flowchart showing a method 1100 for locking in EV charger in an EV charging socket, in accordance with various embodiments.

In step 1110 of method 1100, an electrical signal is received to activate using an electrically controlled actuator.

In step 1120, a mechanical force is applied in a first direction to a plunger using the electrically controlled actuator to move a tip of the plunger through a hole in a channel of an EV charging socket to position the tip in a locking position in the channel to contact a lockable portion of an EV charger inserted into the channel.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. An electrically controlled electric vehicle (EV) charger locking system, comprising:
a plunger for physically contacting a lockable portion of an EV charger inserted into an EV charging socket;
one or more springs that, when uncompressed, position a tip of the plunger in a return position in or above a hole in a channel of the socket and, when compressed, apply a force in a second direction to return the tip to the return position; and
an electrically controlled actuator that, when activated, applies a mechanical force to the plunger in a first direction, which is opposite the second direction, to move the tip through the hole and to position the tip in a locking position in the channel to contact the lockable portion of the charger and, when deactivated, removes the mechanical force from the plunger, allowing the plunger to be returned to the return position by the one or more springs.

2. The system of claim 1, wherein the tip is angled to prevent parallel surface contact between the tip and the lockable portion of the charger.

3. The system of claim 1, wherein the lockable portion comprises a notch.

4. The system of claim 1, wherein the plunger, the one or more springs, and the electrically controlled actuator are enclosed in a housing connected to the socket.

5. The system of claim 1, wherein the electrically controlled actuator comprises a solenoid or a rotary motor.

6. The system of claim 1, wherein the electrically controlled actuator receives an electrical signal to activate and an electrical signal to deactivate from electrical circuitry.

7. The system of claim 6, wherein the electrical circuitry comprises one or more processors.

8. The system of claim 6, wherein the electrical signal to activate is received when the electrical circuitry detects that the charger is charging the socket.

9. The system of claim 6, wherein the electrical signal to deactivate is received when the electrical circuitry detects that the charger is not charging the socket.

10. A method for locking an electric vehicle (EV) charger in an EV charging socket, comprising:
receiving an electrical signal to activate using an electrically controlled actuator;
applying a mechanical force in a first direction to a plunger using the electrically controlled actuator to move a tip of the plunger through a hole in a channel of an EV charging socket to position the tip in a locking position in the channel to contact a lockable portion of an EV charger inserted into the channel.

11. The method of claim 10, wherein one or more springs, when uncompressed, position the tip of the plunger to a return position in or above the hole in the channel and, when compressed, apply a force in a first direction to return the tip to the return position.

12. The method of claim 11, further comprising
receiving an electrical signal to deactivate using the electrically controlled actuator,
removing the mechanical force from the plunger using the electrically controlled actuator, allowing the plunger to be returned to the return position by the one or more springs.

13. The method of claim 10, wherein the tip is angled to prevent parallel surface contact between the tip and the lockable portion of the charger.

14. The method of claim 10, wherein the lockable portion comprises a notch.

15. The method of claim 11, wherein the plunger, the one or more springs, and the electrically controlled actuator are enclosed in a housing connected to the socket.

16. The method of claim 10, wherein the electrically controlled actuator comprises a solenoid or a rotary motor.

17. The method of claim 12, wherein the electrically controlled actuator receives the electrical signal to activate and the electrical signal to deactivate from electrical circuitry.

18. The method of claim 17, wherein the electrical circuitry comprises one or more processors.

19. The method of claim 17, wherein the electrical signal to activate is received when the electrical circuitry detects that the charger is charging the socket.

20. The method of claim 17, wherein the electrical signal to deactivate is received when the electrical circuitry detects that the charger is not charging the socket.
